(19) United States
(12) Patent Application Publication
(10) Pub. No.: US 2004/0246129 A1
(43) Pub. Date: Dec. 9, 2004

(54) Master signal generator with allied servant units to detect range between the master signal transmitter and the allied servant units

(76) Inventor: Christopher M. Goggin, Wilmington, NC (US)

Correspondence Address: MICHAEL E. MAUNEY, SOUTHPORT OFFICE, 801 N. HOWE STREET, P. O. BOX 10266, SOUTHPORT, NC, 28461, US

(21) Appl. No.: 10/453,099

(22) Filed: Jun. 3, 2003

(51) Int. Cl. G08B 1/08

(52) U.S. Cl. 340/539.23

(57) ABSTRACT

A combined radio transmitter/receiver apparatus for determining a particular distance between a transmitter and a receiver. The master transmitter unit sends a radio signal to a servant receiver. The servant receiver has a signal receiver which requires no amplification. When a signal is received from the master transmitter, it generates a current activating a comparator, which then triggers a return signal from a transmitter in the servant unit powered by a shielded battery unit. The master transmitter is set to respond either to receipt of a return signal or failure to receive a return signal. In some applications, the master transmitter will sound a warning to a user when there is no receipts of a returned signal. In other applications, the master transmitter will sound a warning to a user when there is receipt of a return signal. Through the use of tuned antennas in the master transmitter and coded return signals, false alarms and false positives are avoided.

### BACKGROUND OF THE INVENTION

1. Field of the Invention

This invention relates generally to a transmitter and receiver system that will detect whether a receiver system is within a prescribed range of the transmitter. The transmitter will issue a warning to the operator depending upon the range of the receiver to the transmitter.

2. Description of Related Art

A variety of devices use a master transmitter and a servant receiver. These are commonly used to locate lost or misplaced objects. Most commonly the devices cause the servant receiver emit an audible warning or visual warning in response to a signal from the master transmitter. Examples of use of this type device would allow one to locate luggage in a luggage area, a misplaced cell phone, television remote control unit, and so on. A number of problems can be encountered in these kinds of units. First, it is possible to obtain false alarms. Coded signals are frequently used to overcome this handicap (See Bender, U.S. Pat. No. 6,147,602). Because the devices may undergo a long period of time where no use is required, battery drain can be a problem. Sacca et al., U.S. Pat. No. 5,638,050, proposes the receiver cycling in a given time frame. The master transmitter activating signal is timed to be longer than the period of time the signal receiver is off. Hence, the signal receiver will always be on for at least a portion of the activation signal duration and will respond with the appropriate sound or light signal. Cycling the servant receiver on and off preserves battery life. Other patents recognize a need for the audible signal from the servant unit to be sensitive to the distance from the master transmitter. For example, Renney, U.S. Pat. No. 5,939,981, uses multiple sensors that are sensitive to the proximity of the master unit to cause the sensors to issue a louder tone. Rosenthal, U.S. Pat. No. 6,366,202, proposes an acoustic signal with a piezoelectric transducer to receive the signal. A transmitter is received by a resonator, which amplifies it in intensity relative to the intensity of the signal sound wave. Thus, for both the Renney and Rosenthal patents, as the master transmitter comes closer to the servant receiver, the sound output from the servant receiver is increased in response to the proximity of the master transmitter. In the above prior art, the servant receivers are either on constantly or cycle on and off in a given time frame. This represents a considerable drain on the battery, which requires replacing the battery in the servant units every few months.

However, a unique receiver circuit may be used which is powered by the transmitter and requires no powered amplification. The signal from the master transmitter powers the unique antenna circuit, the servant receiver responds to this signal from the master transmitter. In this application, it is proposed that the servant receiver respond with a return RF signal to the master transmitter. Depending on the adjusted range setting of the servant receiver to the master transmitter, the master transmitter will sound an alarm. In one application, this will inform an owner that the owner is more than a prescribed distance from the item to which the servant receiver unit is attached. For example, a master transmitter might be built into a carrying case for electronic items such as a personal data assistant, a lap top computer, and a cell phone. When the owner is in a location where these items are to be used but with danger that they could be lost or left behind, the owner would activate the master transmitter unit within the carrying case so when the owner removed the personal data assistant, lap top computer, or cell phone from the carrying case, the master transmitter would send signals to the servant receivers, which would respond with signals to the master transmitter. As long as the carrying case remained within the predetermined distance from the items which had the servant receiver attached to them, the master transmitter would not sound a warning. However, should the owner pack up and prepare to leave, but by happenstance leave out one of the items like the personal data assistant, as soon as the case passed outside the prescribed range, the master transmitter in the case would sound a warning to the owner telling him, he was about to leave without his personal data assistant. In addition to use with items like a personal data assistant, the servant receiver could be attached to a child or a pet. In the event a child or pet wonders off in a store, a mall, a theme park, or the like, the master transmitter would advise the user at the servant receiver, hence child or pet was no longer within the prescribed range. The master transmitter and servant receiver could be used to also warn the owner when a servant receiver comes within a particular range. For example, the master transmitter could be placed in proximity to an item like an operating piece of machinery, a swimming pool, or an open fire. If a pet or child came within a prescribed distance, say 10 feet, of this potentially dangerous item, an alarm would sound to warn the owner of the proximity of the child or pet to this perceived dangerous item. This unit can be used inside buildings which interfere with receipt or sending of a signal to an antenna or receiver outside of the building. For example, cell phone or GPS units must be able to send or receive signals to an outside antenna or satellite and, for this reason, may not be reliably used inside a building which shields the cell phone or GPS unit from sending or receiving radio signal transmissions. Of course, the servant receiver or TAG unit could also be equipped to respond with a light and sound signal from the master transmitter unit in the event the item was misplaced and assistance was needed in finding it.

### SUMMARY OF THE INVENTION

The servant receiver is maintenance free for a life span of the battery, for example up to 10 years for a lithium ion battery. The servant receiver is approximately the size of a U.S. Quarter in diameter (1 inch) and approximately the thickness of three quarters stacked together (0.21 inches). It can be attached to various objects by bonding or adhering to the bottom surface, a key ring attachment and a clip feature for paper or documents. The servant receiver is a completely sealed product and weather proof. When the servant receiver is activated by the transmitter, it returns a coded signal to master transmitter. The master transmitter can be programmed to signal either receipt of a coded return signal or the failure to receive a coded return signal. The master transmitter will signal by various means including light, sound, and vibration. There is no amplifier required in the servant receiver and a unique antenna circuit generates enough current to activate the servant receiver. An antenna circuit in combination with a low current drain voltage comparator is used to activate a battery-powered transmitter to send the return signal. A radio frequency signal activates the voltage comparator. Only when the radio signal is sent by the transmitter will the servant receiver be activated. In the preferred embodiment the antenna circuit uses no amplification and thus no current drain until the servant receiver is triggered. The comparator uses negligible power.

Both the master transmitter and the servant receivers are ordinarily off. On the master transmitter a thumb button is depressed, which sends out a radio signal to the antenna circuit in the servant receiver which powers up the servant receiver. A low-voltage comparator circuit is situated behind the RF antenna detector. The comparator detector circuit will trigger either an “AND” gate, transistor, or micro controller such as the Texas Instruments chip set MSP430. The comparator acts as an amplifier and opens the return signal transmitter in the servant receiver. A battery is in the servant receiver and operates only when the antenna/diode detector circuit is energized by a signal received from the master transmitter. The battery powers the return signal transmitter in the servant receiver. If a 3-volt battery is used, then a battery is typically good for 250 milliamp hours. The return signal transmitter draws about 3-7 milliamps. Ordinarily, very little time will be required between the time the master transmitter is activated and the servant receiver begins to emit a return signal. Consequently, the 3-volt battery is good for approximately 3-8 years depending on usage. The shelf life of most lithium batteries is 10 years. After the life of the battery, the servant receiver is discarded without the need of replacing the batteries. The bottom of the servant receiver of the current invention is a non-intrusive battleship gray color.

The servant receiver of the current invention can attach to items in four different ways. First, it has an included peel & stick adhesive pad, which is removable, that fits inside the indention of the key ring. This allows for a removable “sticker” option that does not increase the thickness of the servant receiver. Second, the servant receiver of the current invention can be attached using a permanent adhesive. Thirdly, it can be attached by using the fold out key chain located on the bottom side of the receiver. Lastly, it can be attached with a magnetic paper clip. The same rings that swivel out into the key chain act as a magnetized clip that pinches.

### BRIEF DESCRIPTION OF THE DRAWINGS

FIGS. 1A and 1B show different modes of operation of the current invention.

FIG. 2 is an exploded view of a servant receiver.

FIG. 3 is a detailed view of the shielded battery.

FIG. 4A is a view of the loop antenna.

FIG. 4B is a simplified diagram of the servant receiver.

FIG. 4C is a simplified circuit diagram of the receiver unit of the servant receiver.

FIGS. 4D, 4E, 4F, and 4G show ground planes.

FIG. 5 is the master transmitter.

FIG. 6 is an exploded view of the master transmitter seen from a belt clip side of the master transmitter unit.

FIG. 7 is an exploded view of the master transmitter seen from the control side of the master transmitter unit.

FIG. 8 is a flow chart of operation of the invention.

### DETAILED DESCRIPTION OF THE DRAWINGS

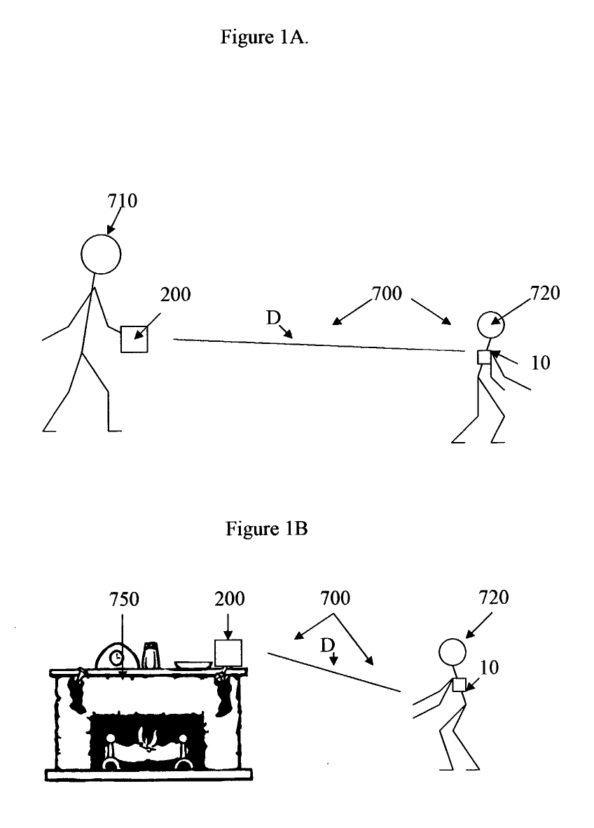

FIGS. 1A and 1B show in rough outline form two potential modes of operation for the range sensing transmitter and receiver invention (700). In FIG. 1A, a master transmitter (200) is in the hand of a user (710). The servant receiver (10) is attached to a child (720). As will be explained later, the master transmitter (200) is set to a particular sensitivity to a distance (D) between the master transmitter (200) and the servant receiver (10). If the child (720) wanders off from the user (710) so that the separation in distance between the master transmitter (200) and the servant receiver (10) exceeds the preset distance (D), then the master transmitter (200) will issue a signal that can be perceived by the user (710) alerting the user (710) that the preset distance (D) between the master transmitter (200) and the servant receiver (10) has been exceeded. In this case, the user (710), a parent or guardian, will then immediately be alerted to the fact that the child (720) is no longer within the preset distance (D) and may take appropriate action.

In FIG. 1B, the master transmitter (200) is placed in proximity to a perceived dangerous condition, shown here as an open fireplace (750). Again, the servant receiver (10) is placed on a child (720) and the master transmitter (200) again has a preset distance (D) so it will be sensitive to return signals sent by the servant receiver (10) in response to signals transmitted by the master transmitter (200). However, here, the mode of operation of the master transmitter (200) is reversed. There is a preset distance (D). The master transmitter (200) sends out a signal. The signal will activate the servant receiver (10) to respond with a return signal when the servant receiver is a preset distance (D) or less from the master transmitter (200). In FIG. 1A, when the master transmitter (200) was no longer receiving a return signal from the servant receiver (10), it signaled this fact through some perceptible signaling device. However, in FIG. 1B, the mode of operation is reversed so that when the servant receiver (10) comes within the preset distance (D), the master transmitter (200) begins to signal a perceivable signal. In FIG. 1A, the master transmitter (200) sounds a warning when the preset distance (D) between the master transmitter (200) and the servant receiver (10) is exceeded. In FIG. 1B, the master transmitter (200) sounds a warning when the servant receiver (10) is inside the preset distance (D). In this fashion, a user (not shown) in FIG. 1B would be made aware that a child (720) had approached a hazard like an open fireplace (750).

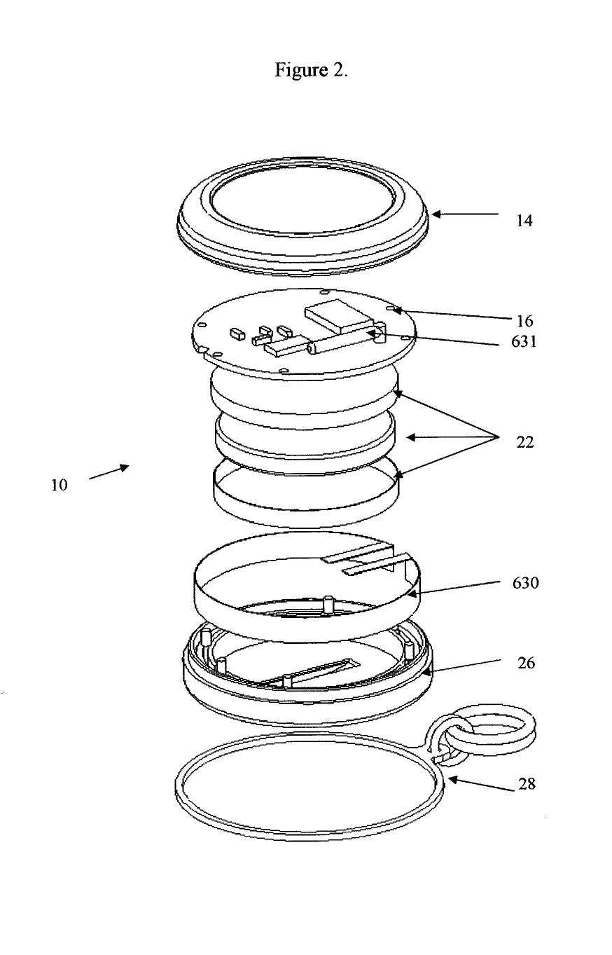

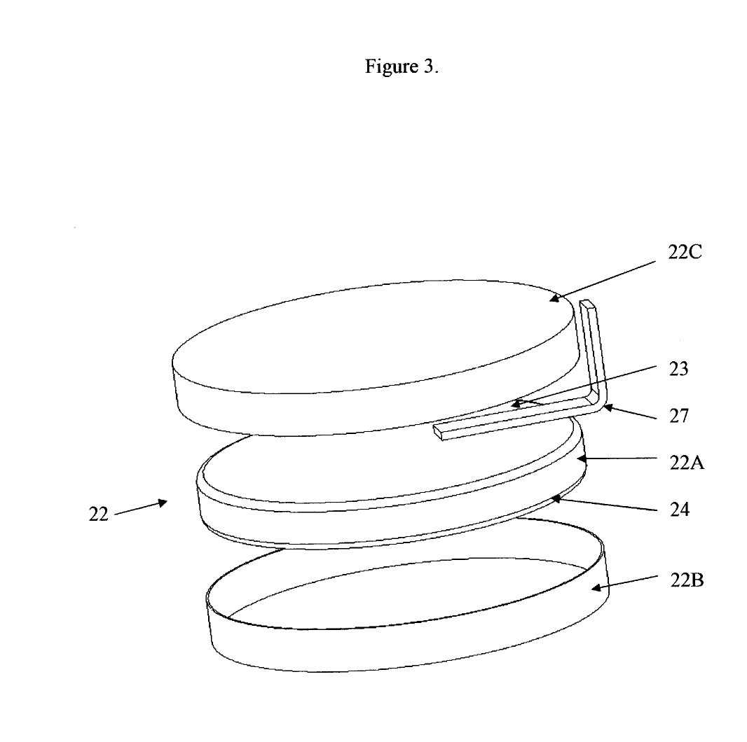

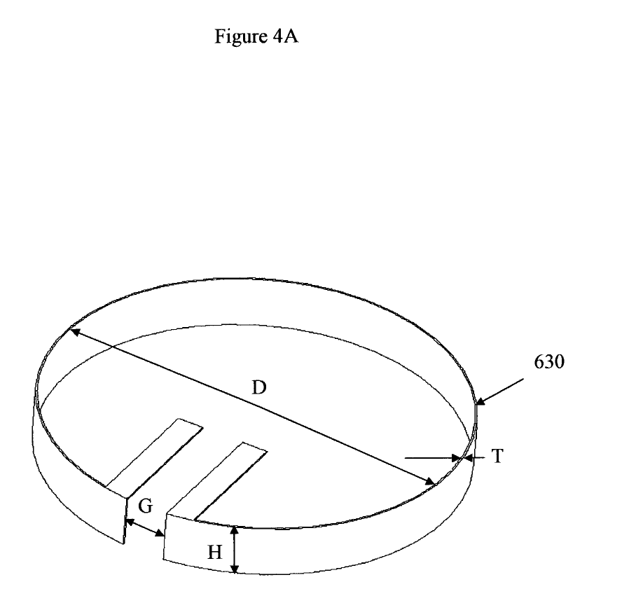

FIG. 2 shows an exploded perspective view of the servant receiver (10). The top cover (14) connects to the lower case (26) when assembled with the remaining pieces shown in the exploded view contained therein. Immediately below the top cover (14) is the circuit board (16). On the circuit board (16) is a transmitting antenna (631) used by the servant receiver (10) to transmit coded return signals to the master transmitter (200). Below the circuit board (16) is an exploded view of the shielded battery assembly (22). The shielded battery assembly (22) is seen in more detail in FIG. 3. Below the shielded battery assembly (22) is a loop antenna (630) used for receiving signals from the master transmitter (200) shown in FIGS. 5, 6, and 7. The lower case (26) is molded to accept the shielded battery assembly (22), the loop antenna (630), the circuit board (16), and the top cover (14). Attached to the bottom of the lower case (26) is the clip assembly (28).

FIG. 3 shows the shielded battery assembly (22). Contained within the battery assembly (22) is the battery (22A). The battery (22A) will ordinarily be a lithium ion coin-size battery. The battery (22A) fits within and is contained within the battery can (22B) while the battery shield (22C) is somewhat larger in dimension and fits around the battery can (22B). The battery (22A) has an anode (23) and a cathode side (24) and is appropriately electrically connected with conductive material to power the circuit board (16) for the purpose of sending a return signal to the master transmitter by means of the transmitting antenna (631). On the anode side (23) of the battery (22A), a conductive insulated ribbon wire (27) extends from the anode side (23) of the battery (22A). The anode side (23) of the battery (22A) is insulated from contact with the battery shield (22C) and the battery can (22B). A thin plastic film (not shown) can be used for this purpose and can fit over and around the anode side (23) of the battery (22A). A conductive insulated ribbon wire (27) extends from the anode side (23) of the battery (22A) and fits between the sides of the battery shield (22C) and the battery can (22B) for connection to an anode connection on the circuit board (16). The cathode side (24) of the battery (not seen in this view) connects directly to the battery can (22B). Consequently, the entire shielded battery assembly (22) serves as the anode and connects directly to the bottom of the circuit board (16) for completing the circuit connection. The battery can (22B) and battery shield (22C) are ordinarily made of a conductive metallic material and, in practice, carbon steel has been found to work well. The purpose of shielding the battery (22A) is that it is believed that the battery generates a small magnetic field which can interfere with the receiver circuit on the circuit board (16). In practice, it has been shown that the radio frequency portion of the receiver circuit on the circuit board (16) works better when the battery (22A) is shielded than when it is not.

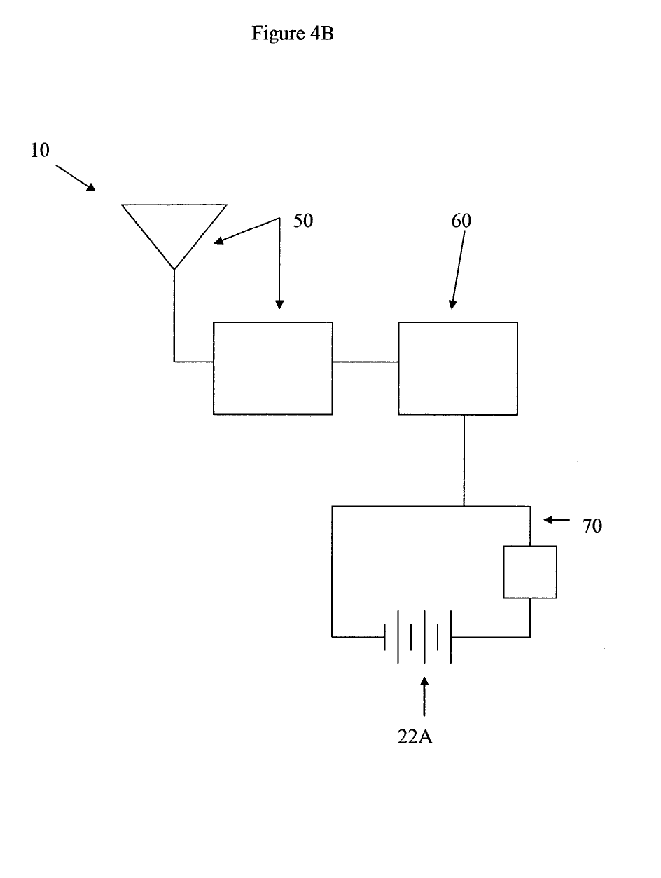

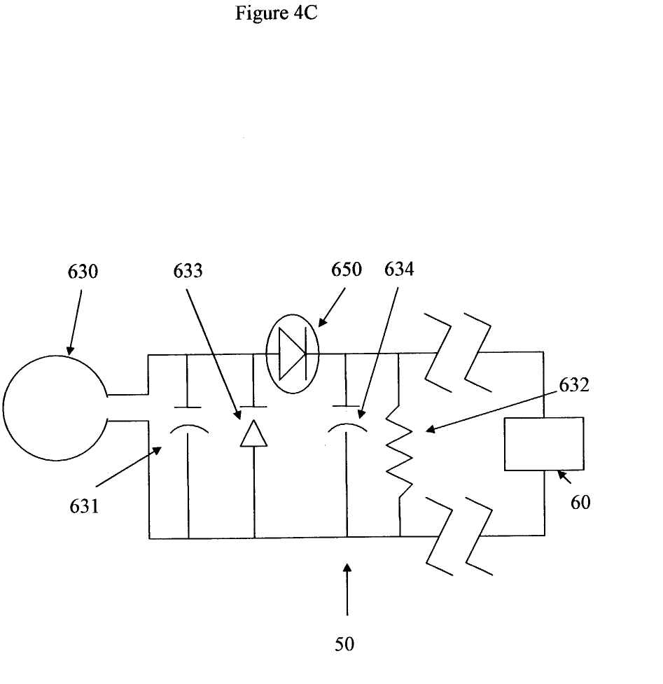

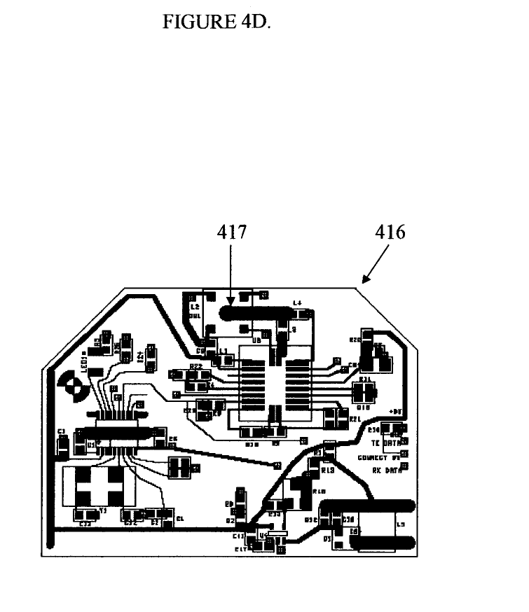

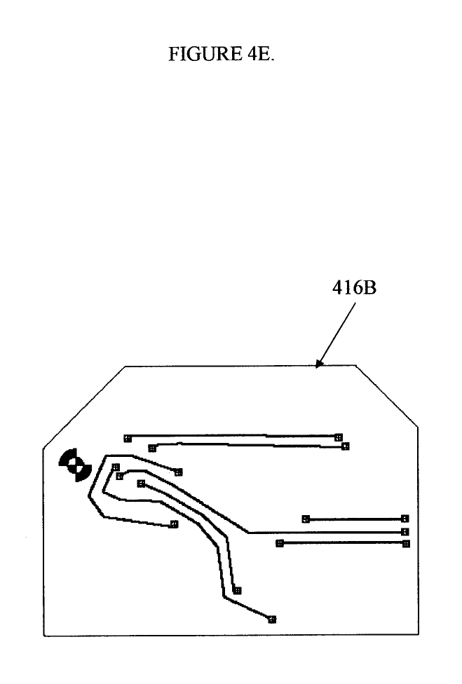

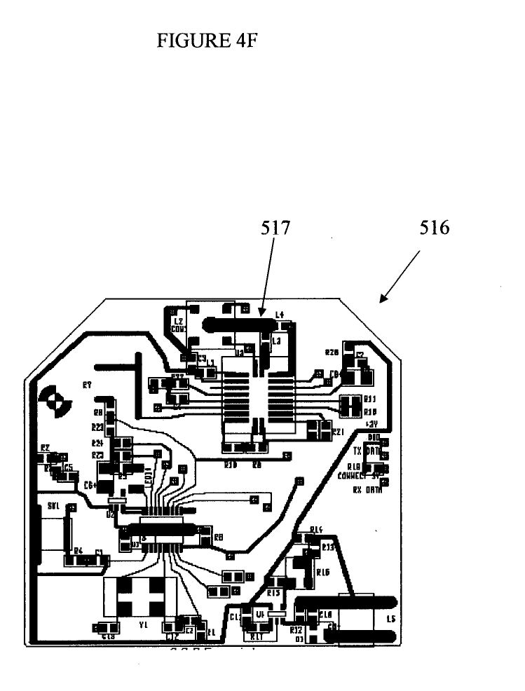

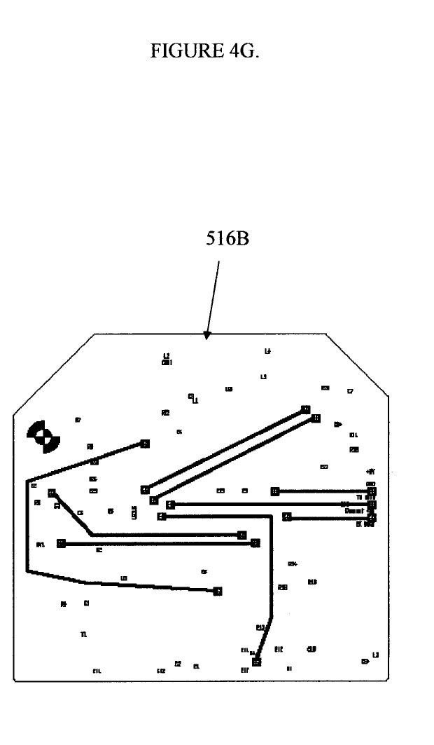

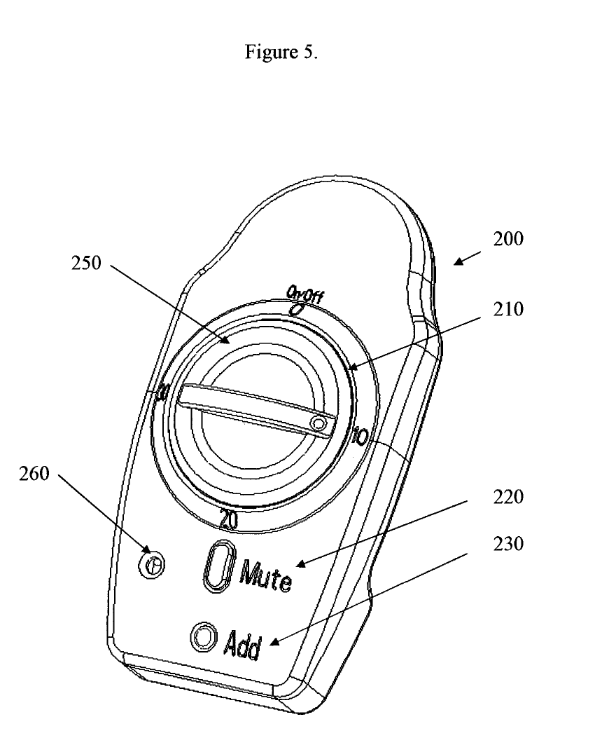

FIG. 4A shows in more detail the loop antenna (630). The loop antenna (630) may be tuned to different frequencies by changing the dimensions of the loop antenna (630). For example, 2.4 GHz could be used in some applications, which would make the antenna shorter and more compact where it is necessary to reduce the size of the servant receiver. In one embodiment, the loop antenna (630) is tuned to 418 MHz for several reasons. First, 418 MHz is relatively free of common usage in the U.S. and Europe. This will reduce, if not eliminate, false triggerings by stray radio frequency signals in nearby radio frequency bands. At this frequency the transmitter may operate with enough power to trigger a response at 50 feet, while still remaining compliant with FCC Rule 47 C.F.R. Part 15, Section 15.231, for periodic operation. The loop antenna (630), when tuned to 418 MHz, is generally circular and has a diameter (D) of 0.98 inches. It is 0.125 (⅛) inches high (H) and is constructed of thin metallic foil 0.004 inches in thickness (T). The metallic foil is preferably formed from copper (CU), nickel (Ni) or tin (Sn). The gap (G) of the loop antenna (630) is approximately 0.10 inches. The 2.4 Ghz loop antenna (630) is constructed with different dimensions than is the loop antenna (630) tuned to the 418 MHz but in the same generally circular shape with a diameter (D) of 0.375 inches. It is 0.07 inches high (H) and is constructed of a thin metallic foil, ordinarily copper, 0.015 inches in thickness (T). The gap (G) of the loop antenna (630) for the 2.4 GHz signal is approximately 0.03 inches. This loop antenna (630) can be used to receive the particular frequency signed for both the servant receiver (10) and the master transmitter (200). FIG. 4B shows a simplified block diagram for the servant receiver (10). The servant receiver (10) consists of three separate operating components. First, is a signal receiver unit (50). The signal receiver unit (50) is activated by receipt of a radio frequency. The signal receiver unit (50) activates the voltage comparator (60). Neither the signal receiver unit (50) nor the voltage comparator (60) will require any significant current to operate. It will be active in stand-by mode at all times without draining the battery (22A). The voltage comparator (60) may use a negligible amount of current in the stand-by mode. One particular voltage comparator manufactured by Texas Instruments uses 1.2 microamps in the stand-by mode. For purposes of this application, if the current drain caused by the voltage comparator (60) is so small that it will not substantially reduce the ordinary shelf life of the battery, this current drain will be deemed negligible. When a radio frequency signal is received by the signal receiver (50), the signal receiver (50) generates a small current, which activates the voltage comparator (60). The voltage comparator (60) activates the output unit (70). The output unit (70) will consist of at least a standard radio frequency transmitter that sends out a 16 bit character at 418 MHz. The 16 bit character gives 64,000 possible codes. The code for a particular servant receiver will be in permanent memory in a controller chip. The output unit (70) could also be equipped, in addition to a radio frequency transmitter, with a light emitting diode or a piezoelectric buzzer so that, if desired, a different signal from the master transmitter could activate the sound and light output features of the output unit (70).

FIG. 4C shows a simplified circuit diagram for the signal receiver (50) using the loop antenna (630). The loop antenna (630) will be matched with a detector diode (650) and voltage divider diode (633) with appropriate capacitors (631) and (634) and resistance (632). For a loop antenna (630) for a 418 MHz signal, described above in FIG. 3, the detector diode (650) will be a zero bias Schottsky detector diode. For this particular circuit, an Agilent Technologies diode assigned part #HSMS-2852-BLK will serve. The capacitor (631) would be from 0.6 to 6 pico farads and the capacitor (634) is 220 pico farads. The resistor (632) is 620 kilohms. This design has a high ability to discriminate in responding to a particular frequency, hence, it is said to have a “high Q”. For a 2.4 GHz signal, some of the capacitors and resistors would need to be adjusted in the signal receiver (50). The combination of the loop antenna (630) with the resistor (632), capacitors (631) and (634), detector diode (650), and ground planes (17) shown in FIGS. 4D, 4E, and 4F act as the signal receiver unit (50) in FIG. 4B. A 418 MHz low power radio signal compliant with FCC requirements is sufficient to cause the signal receiver unit (50) to generate a low-voltage signal, which is sent to the comparator (60). Particular micro-comparators that may be used in this application are the Texas Instruments comparator #TI TLV37021DK (8 pin dual OPAMP low power rail-to-rail) or #TI TLV37011 DBV (5 pin single OPAMP low power rail-to-rail). These micro-comparators are sensitive below 0.1 millivolts. This particular signal receiver unit (50) design permits use of this Texas Instruments component at a very low sensitivity. This permits FCC compliance for signals from the master transmitter (200) while still permitting the servant receiver (10) to be triggered at more than 50 feet from the master transmitter (200) without any kind of active amplifying circuit in the servant receiver (10).

FIGS. 4D, 4E, 4F, and 4G show embodiments of the copper ground plane used in the master transmitter (200) and the servant receiver (10). FIG. 4D shows a copper ground plane (417) for the servant receiver (10) on the printed circuit board (416). The copper connections are shown in black in the FIG. 4D. In order to simplify the connections on the printed circuit board (416), the copper ground plane (417) is layered, with connections being made on a separate printed circuit board (416B) rather than attaching wires to the printed circuit board (416). The separate printed circuit board (416B) is shown in FIG. 4E. Again, the copper on the printed circuit board (416B) is shown in black. The printed circuit board (416B) can be thought of as an overlay or an underlay on the primary printed circuit board (416) and copper ground plane (417). FIG. 4F shows again the primary printed circuit board (516) for the master transmitter (200) with the copper ground plane (517) shown in black. FIG. 4G shows a printed circuit board (516B) which is used to make connections on the primary printed circuit board (516). Again, the copper is shown in black on the circuit board (516B). This eliminates the need for protruding wires above the printed circuit board (516) used for the master transmitter. It will be understood by one skilled in the art the various alternative designs for the printed circuit board and copper ground plane could be employed. Those shown in FIGS. 4D, 4E, 4F and 4G are shown to illustrate the preferred embodiment. It is also believed these particular ground planes provide a more efficient functioning for both the master transmitter (200) and the servant receiver (10) than do known alternate ground planes or printed circuit boards for these devices.

FIG. 5 shows the master transmitter (200). On the master transmitter (200), there is a combined on/off sensitivity control (210). This is used both to turn the master transmitter (200) on and off and to set the degree of sensitivity of the master transmitter (200). The master transmitter (200) is designed to transmit and receive a signal from the servant receiver unit (10). If the user of the master transmitter (200) desires to be warned when the servant receiver (10) is more or less than 10 feet from the master transmitter (200), the device will be set at 10 using the sensitivity control (210). In FIG. 5, it is shown at 10 feet. It will be explained in more detail for later figures how the sensitivity control (210) operates. There is a mute button (220), which can be used to prevent the master transmitter (200) from sounding a warning or alarm. A light ring (250) will signal a warning by lighting. A buzzer (260) will buzz to signal a warning. When in the “mute” mode, the master transmitter (200) will silently vibrate to advise a user of the status of a return signal. There is an add button (230), which allows additional servant receiver units to be added. The master transmitter (200) has the capability of recognizing over 64,000 coded signals to serve 64,000 different servant receivers. The add button (230) will code a new or additional servant receiver for use with a particular master transmitter. As was explained for FIGS. 1A and 1B, the master transmitter (200) may operate to give a warning when the servant receiver (10) is more than the sensitivity control setting from the master transmitter (200) or it may give a warning when the servant receiver (10) is at or less than the setting of the sensitivity control (210). It will be a matter of commercial application as to whether a master transmitter may only operate in one mode or whether a single master transmitter may operate in both modes according to a control switch. Having a master transmitter (200) which can operate in both modes, depending on the setting of a control switch, could be a potential problem because if a user sets the master transmitter in the wrong mode, then it will not perform its intended function. However, whether the master transmitter (200) is sold for a single mode operation or for dual mode operation is a matter of commercial convenience unrelated to the overall functioning of the device.

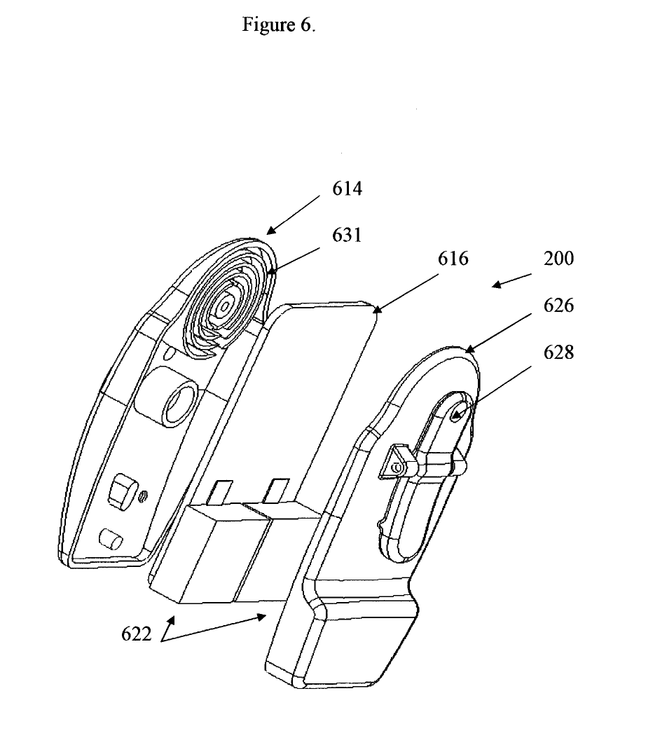

FIG. 6 shows the master transmitter (200) in an exploded view as seen from the belt clip side (628). On the bottom cover (626) of the master transmitter (200) is a belt clip (628) for use to attach the master transmitter (200) to a belt or to any other convenient point where the clip (628) could be used for attachment. The top cover (614) connects to the bottom cover (626). Attached to the top cover (614) is a transmitting antenna (631), for transmission of coded signals, which is conductively connected to the control PC board (616). The batteries (622) are seen at the bottom of the control board (616), which are used to power the master transmitter (200). The master transmitter will also use the loop antenna (630) (not shown) to receive stray 418 or 2.1 Ghz signals to avoid false positives as is described below.

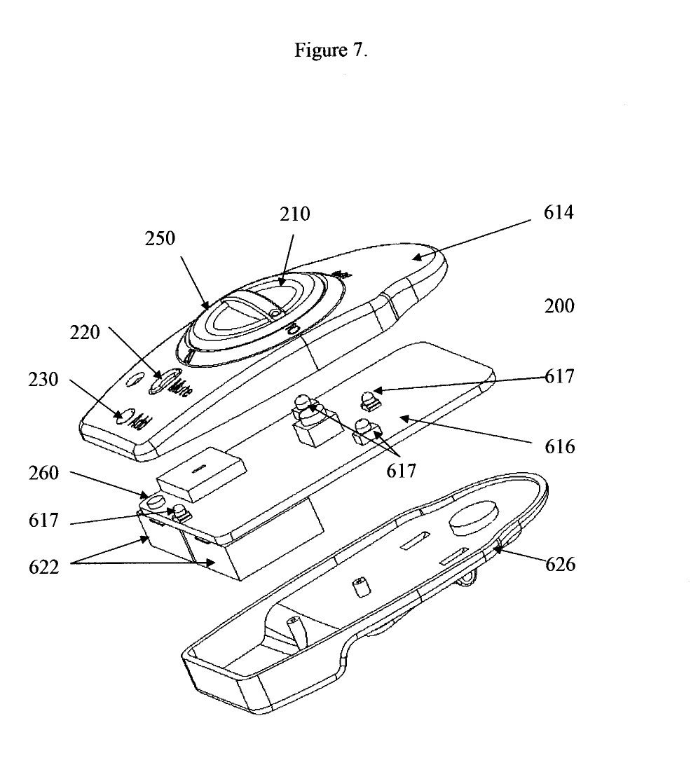

FIG. 7 shows the master transmitter (200) when seen from the control dial (210) or top cover (614) side. Seen on the PC control board (616) are LED's (617), which are used to light the control dial (210) and the add button (230) and the light ring (250). A buzzer (260) is also mounted on the PC control board (616). The control dial (210) is a 5 k ohm potentiometer which adjusts to increase the resistance to limit the power of the transmission sent out through the antenna (631). It functions not unlike a volume control and is increased or decreased to decrease the power of the radio signal of the transmission being broadcast by the antenna (631). The loop antenna (630) (not shown) and associated circuits in the servant receiver (10) will only activate the comparator (60) causing a return signal when a transmitted signal from the master transmitter (200) has sufficient power. Consequently adjusting the power of the signal transmitted by the master transmitter (200) effectively adjusts the distance which will cause a return signal from the servant signal (10). The circuit board (616) is a one piece device with a microcontroller, code circuit, receiver, and transmitter. The microcontroller has memory which can store 16 bit characters which are characteristic of the return signal of the servant receiver (10). The controller uses the 16 bit characters also to match the return signal codes. One transceiver that is found to operate effectively in practice is a Texas Instruments transceiver assigned parts number TRF6900. The remaining part of the controls including memory, microcontroller, timer and the like can be found in a single chip set. The Texas Instruments MSP430 chip set has been found in practice to work well in this application.

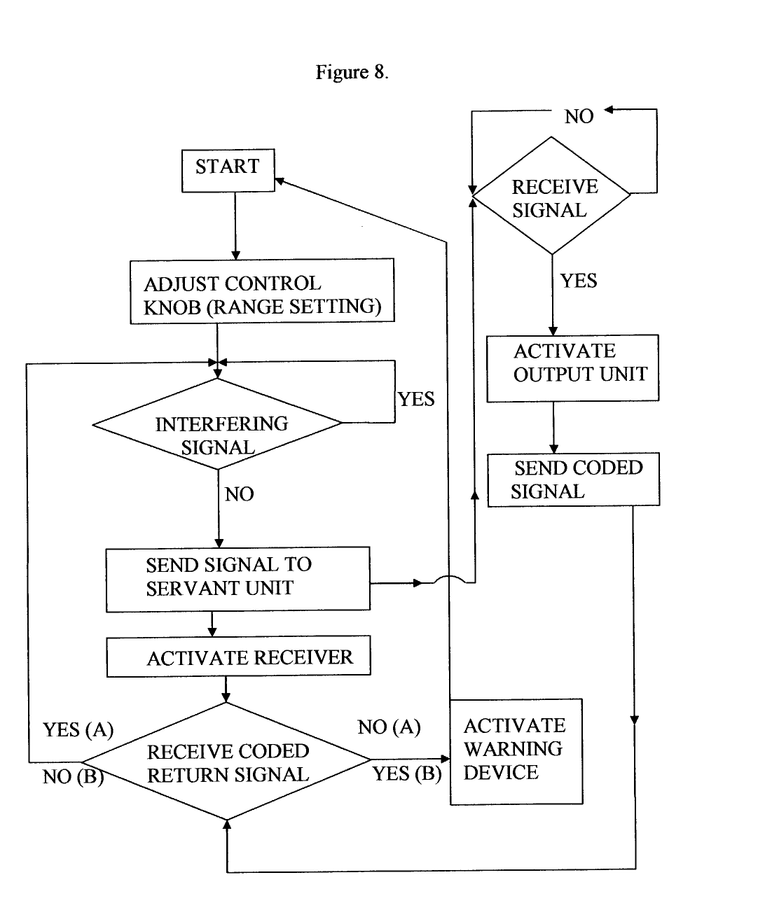

FIG. 8 shows in flow chart form the operation of the master transmitter (200) with a servant receiver (10). The operation of the master transmitter (200) is shown on the left in FIG. 7, while the operation of the servant receiver (10) is shown on the right in FIG. 7. The operator will start the operation of the unit by turning on the master transmitter (200) and adjusting the control dial (210) to a desired degree of proximity. The master transmitter (200) will be equipped with loop coil antenna (630) tuned to a particular frequency. An identical loop coil antenna (630) will be placed in the servant receiver (10). The servant receiver (10) responds to any signal received by its loop coil antenna (630). In order to avoid false alarms, it is necessary that the master transmitter (200) be equipped to only recognize return coded signals from the servant receiver (10) which are made in response to an activating signal sent by the master transmitter (200). Consequently, the master transmitter (200) will check to see if there is any interfering signal present by using the tuned loop coil antenna (630). If there is another master transmitter (200) nearby, being operated by another consumer, then there might be an interfering signal. Consequently, the master transmitter (200) will wait until the air is clear before activating a signal to be sent to the servant receiver (10). However, if the master transmitter (200) determines there are no interfering signals on the particular wave length present, the master transmitter (200) will then send a signal using the transmitter antenna (631) for receipt by the servant receiver (10). The signal will be a short burst signal of a predetermined duration. FIG. 7 shows the operation of only one servant receiver (10). Because the signal transmission may be for only a fraction of a second, it will be possible for the master transmitter (200) to cycle through a relatively high number of signal transmissions, receptions, and reactions in a relatively short period of time. Consequently, there will be some delay between the sending of a first coded signal to a first servant receiver (10) and the sending of a repeat signal to a first servant receiver (10). Two seconds would be an ordinary delay that might be employed between signals. The transmission of a signal is received by the loop antenna (630) in the servant receiver unit (10). The servant receiver (10) turns on the output unit. The output unit then sends a coded return signal. In mode ‘A’, as seen in FIG. 1A, if the coded return signal is received by the master transmitter (200), then the master transmitter (200) will send another signal after an appropriate delay. In this way, there is in effect a “dialog” between the master transmitter (200) and the servant receiver (10). As long as the servant receiver (10) answers with a coded return signal that can be heard by the master transmitter (200), the dialog is entirely silent. However, should the servant receiver (10) fail to return a coded signal or fail to return a coded signal of sufficient strength to be received by the master transmitter (200), then the master transmitter (200) activates a warning device. This can be a light, a sound, a vibrator, or some other means to direct the user's attention to the fact that no coded signal was received from one of the servant units in operation. This directs a user's attention to the fact that the item to which the servant receiver (10) is attached has now left the proximity determined by the adjustment to the control dial (210). Depending on the user and the circumstance, it could mean the user has left the room without his Palm Pilot or that a child has strayed in a shopping mall. At this point, a user may take a variety of actions to remedy the problem brought to the user's attention by the warning device. In mode ‘B’, as seen in FIG. 1B, the operation of the master transmitter (200) is reversed. The master transmitter (200) will continue to send a signal as long as there is no coded return signal. However, as soon as the master receiver receives a coded return signal from the servant receiver, then the master transmitter activates a warning device. In FIG. 8, of the operation of the flow chart for the master transmitter (200) for modes ‘A’ and ‘B’ are respectively labeled “A” and “B” in the decision mode at the bottom of the flow chart for the master transmitter (200). Thus, in mode ‘B’, when the master transmitter (200) receives a coded return signal, then the master transmitter (200) activates a warning device. Again, this could be a light, a sound, a vibrator, or some other means to direct the user's attention to the fact that a coded signal was received from one of the servant units in operation. This directs a user's attention to the fact that the item to which the servant receiver is attached, has now entered predetermined distance. In most circumstances, this would advise the user that a pet or a child has entered an area and that this action requires the attention of a user, perhaps to respond to a danger posed by a fireplace to a child, or to keep a pet from destroying food, or for any other reason that meets a user's need. However, once the master transmitter (200) has sounded a warning to a user, then a user may take appropriate action in response to that warning.

The servant receiver (10) will also use a Texas Instrument MSP430 chip set to broadcast a coded signal to the master transmitter (200). In order to simplify the circuitry in the servant receiver (10) the servant receiver will respond to any transmission of sufficient strength to trigger the comparator (60). However, it will respond with a coded signal unique to that servant receiver (10). The master transmitter (200) will receive the coded signal if the master transmitter (200) receiver is activated by a recent signal broadcast to a servant receiver unit (10). The master transmitter (200) will recognize that signal as a return signal and not sound an alarm. If the servant receiver (10) sent a coded signal in response to an interfering signal sent by another master transmitter (200) or just a stray signal on the correct frequency, the master transmitter (200) would not respond because the receiver in the master transmitter (200) is only activated after a signal is sent by that particular master transmitter (200).

I claim:

1. A radio apparatus for determining a particular distance between a transmitter and a receiver comprising:
(a) a master transmitter/receiver unit with means for transmitting a master signal;
(b) at least one servant receiver/transmitter, said at least one servant receiver/transmitter having a signal receiver unit for receipt of said master signal generated by said master transmitter/receiver unit, said master signal from said master transmitter/receiver unit generating a current in said signal receiver unit, said signal receiver unit operatively connected to a comparator unit for transmission of said current to said comparator unit; said comparator unit operatively connected to a servant transmitter in said at least one servant receiver/transmitter unit, said comparator unit triggering a servant signal from said servant transmitter, said servant transmitter unit powered by a servant transmitter battery;
(c) in said master transmitter/receiver unit, a master receiver responsive to said servant signal sent by said at least one servant receiver/transmitter;
(d) a warning output unit in said master transmitter/receiver that responds depending on whether or not there is reception of the servant signal;
whereby said at least one servant receiver/transmitter unit uses negligible current from said servant transmitter battery until activated by said master signal from said master transmitter unit so that the effective life of said servant transmitter battery is approximately the same as the shelf life of said servant transmitter battery.

2. A radio apparatus for determining a particular distance between a transmitter and a receiver of claim 1 further comprising a means for controlling the output power of said master signal;

3. A radio apparatus for determining a particular distance between a transmitter and a receiver of claim 2 wherein said warning output unit sounds a warning if there is no reception of a servant signal following transmission of a master signal.

4. A radio apparatus for determining a particular distance between a transmitter and a receiver of claim 3 wherein said servant transmitter battery is shielded.

5. A radio apparatus for determining a particular distance between a transmitter and a receiver of claim 4 wherein said at least one servant receiver/transmitter unit further includes means for encoding said servant signal.

6. A radio apparatus for determining a particular distance between a transmitter and a receiver of claim 5 wherein said master transmitter/receiver unit further includes means for recognizing a coded servant signal.

7. A radio apparatus for determining a particular distance between a transmitter and a receiver of claim 6 wherein said signal receiver unit includes an antenna of a definite shape tuned to a definite radio frequency and having a high-Q.

8. A radio apparatus for determining a particular distance between a transmitter and a receiver of claim 7 wherein said signal receiver unit has a copper ground plane of a definite shape.

9. A radio apparatus for determining a particular distance between a transmitter and a receiver of claim 8 wherein said master transmitter/receiver unit has said antenna of said definite shape for said definite radio frequency.

10. A radio apparatus for determining a particular distance between a transmitter and a receiver of claim 9 wherein said master transmitter/receiver unit has logic means for determining if there is a radio signal received by said antenna of definite shape wherein said master transmitter/receiver unit will not send a master signal until there is no receipt of a radio signal received by said antenna of definite shape.

11. A radio apparatus for determining a particular distance between a transmitter and a receiver of claim 2 wherein said warning output unit sounds a warning if there is reception of a servant signal following transmission of a master signal.

12. A radio apparatus for determining a particular distance between a transmitter and a receiver of claim 11 wherein said servant transmitter battery is shielded.

13. A radio apparatus for determining a particular distance between a transmitter and a receiver of claim 12 wherein said at least one servant receiver/transmitter unit further includes means for encoding said servant signal.

14. A radio apparatus for determining a particular distance between a transmitter and a receiver of claim 13 wherein said master transmitter/receiver unit further includes means for recognizing a coded servant signal.

15. A radio apparatus for determining a particular distance between a transmitter and a receiver of claim 14 wherein said signal receiver unit includes an antenna of a definite shape tuned to a definite radio frequency and having a high-Q.

16. A radio apparatus for determining a particular distance between a transmitter and a receiver of claim 15 wherein said signal receiver unit has a copper ground plane of a definite shape.

17. A radio apparatus for determining a particular distance between a transmitter and a receiver of claim 16 wherein said master transmitter/receiver unit has said antenna of said definite shape for said definite radio frequency.

18. A radio apparatus for determining a particular distance between a transmitter and a receiver of claim 17 wherein said master transmitter/receiver unit has logic means for determining if there is a radio signal received by said antenna of definite shape wherein said master transmitter/receiver unit will not send a master signal until there is no receipt of a radio signal received by said antenna of definite shape.

19. A master transmitter/receiver with allied servant receiver/transmitter units comprising:
(a) a master radio transmitter/receiver unit which transmits a radio signal of a predetermined power;
(b) at least one servant receiver/transmitter, said at least servant receiver/transmitter utilizing a signal receiving unit having no amplification and requiring negligible power to remain in the active receiving mode; said signal receiver unit generates an electrical current upon receipt of said radio signal of a predetermined power from said master transmitter/receiver unit;
(c) means for using said electrical current to trigger a return signal from said servant receiver/transmitter to said master transmitter unit;
(d) in said master transmitter/receiver unit means for determining if said return signal was generated from said servant receiver/transmitter and taking a predetermined action in response to said return signal;
whereby said predetermined radio signal from said master transmitter/receiver triggers a returned signal from said servant receiver/transmitter whenever said servant receiver/transmitter is within a predetermined distance of said master transmitter/receiver.

20. A master transmitter/receiver with allied servant receiver/transmitter units of claim 19 wherein said master transmitter/receiver unit said radio signal of a predetermined power is at a particular frequency and said signal receiver unit in said servant receiver/transmitter contains an antenna and comparator unit tuned to said particular frequency, said antenna and comparator units having a high-Q for said radio signal of a predetermined power of said particular frequency.

21. A master transmitter/receiver with allied servant receiver/transmitter units of claim 20 wherein said master transmitter/receiver unit further contains means for determining if a signal is said return signal from said servant receiver/transmitter whereby false positives are eliminated.
